(19) United States
(12) Patent Application Publication
(10) Pub. No.: US 2023/0360830 A1
(43) Pub. Date: Nov. 9, 2023

(54) SUPERCONDUCTING ELECTROMAGNET DEVICE AND COOLING METHOD OF SUPERCONDUCTING ELECTROMAGNET DEVICE

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Saki SAKAMOTO, Yokohama Kanagawa (JP); Shohei TAKAMI, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/354,343

(22) Filed: Jul. 18, 2023

Related U.S. Application Data
(63) Continuation of application No. PCT/JP2021/029893, filed on Aug. 16, 2021.

(30) Foreign Application Priority Data
Mar. 2, 2021 (JP) 2021-032355

(51) Int. Cl. H01F 6/04

(52) U.S. Cl. CPC H01F 6/04; H01F 6/06

(57) ABSTRACT

There is provided a superconducting electromagnet device which can suppress heat generation by an eddy current of a cooling sheet for cooling a superconducting coil to thereby cool the superconducting coil efficiently, and a cooling method thereof. The superconducting electromagnet device includes: a superconducting coil generating a magnetic field; a cooling mechanism cooling the superconducting coil; a radiation shield housing the superconducting coil thereinside to prevent heat intrusion from the outside; and a vacuum vessel for vacuum insulation which houses the radiation shield, wherein the cooling mechanism includes: a circumferential cooling unit having a plurality of strip-shaped circumferential cooling sheets arrayed each with an interval along a circumferential direction of the superconducting coil; and an axial cooling unit having a plurality of strip-shaped axial cooling sheets arrayed each with an interval along an axial direction of the superconducting coil.

### CROSS REFERENCE TO RELATED APPLICATIONS

The present application is a continuation application of International Application No. PCT/JP2021/29893, filed Aug. 16, 2021, which claims priority to Japanese Patent Application No. P2021-032355, filed Mar. 2, 2021. The contents of these applications are incorporated herein by reference in their entirety.

### FIELD

Embodiments of the present invention relate to a superconducting electromagnet device and a cooling method of the superconducting electromagnet device.

### BACKGROUND

A conventional superconducting electromagnet device or the like of a conduction cooling type which has a saddle-shaped coil includes a superconducting coil generating a magnetic field, a cooling mechanism cooling the superconducting coil, a radiation shield preventing heat intrusion from the outside, and a vacuum vessel for vacuum insulation. In addition, a pure aluminum sheet with a wide width has been installed on the superconducting coil along an axial direction thereof, as a cooling sheet disposed in an outer circumference or the like of the superconducting coil and constituting the cooling mechanism to cool the superconducting coil.

In the conduction cooling type superconducting coil described above, when a pulse current flows, an eddy current may occur in the pure aluminum sheet by an interlinkage magnetic flux of the coil, thereby generating heat. Due to heat generation by the eddy current, there have been problems that the number of chillers is required to be increased corresponding to a heating value and that a heat generation place causes a quench.

The present invention is made to cope with the conventional circumstances described above, and is aimed at providing a superconducting electromagnet device which can suppress heat generation by an eddy current of a cooling sheet for cooling a superconducting coil to thereby cool the superconducting coil efficiently, and a cooling method of the superconducting electromagnet device.

### BRIEF DESCRIPTION OF THE DRAWINGS

FIG. 1 A view schematically illustrating a configuration of a superconducting electromagnet device according to a first embodiment

FIG. 2 A view explaining a winding shape of a superconducting wire of a saddle-shaped superconducting coil

FIG. 3 A view schematically illustrating an example of a shape in an axial direction of a superconducting coil

FIG. 4 A view schematically illustrating an example of a shape in a circumferential direction of a superconducting coil

FIG. 5 A view schematically illustrating an example of a shape in a circumferential direction of a superconducting coil

FIG. 6 A view schematically illustrating a configuration of a cooling sheet in a circumferential direction of a superconducting coil of the first embodiment

FIG. 7 A view schematically illustrating a configuration of the cooling sheet in the circumferential direction of the superconducting coil of the first embodiment

FIG. 8 A view schematically illustrating a configuration of the cooling sheet in an axial direction of the superconducting coil of the first embodiment

FIG. 9 A view schematically illustrating an example of the configuration of the cooling sheet in the circumferential direction and the axial direction of the first embodiment

FIG. 10 A view schematically illustrating another example of the configuration of the cooling sheet in the circumferential direction and the axial direction

FIG. 11 A perspective view schematically illustrating a schematic configuration of the cooling sheet of the first embodiment

FIG. 12 A view schematically illustrating a condition of a connected state in a dendrite form of the cooling sheets

FIG. 13 A view schematically illustrating a configuration of a cooling sheet in a circumferential direction of a superconducting coil of a curved shape

FIG. 14 A view schematically illustrating a configuration of a superconducting coil of a second embodiment

FIG. 15 A view schematically illustrating a configuration of a substantial part of the superconducting coil of the second embodiment

FIG. 16 A view schematically illustrating a configuration of a superconducting coil of a third embodiment

FIG. 17 A view schematically illustrating the configuration of the superconducting coil of the third embodiment

FIG. 18 A view schematically illustrating a configuration of a superconducting coil of a modification example of the third embodiment

FIG. 19 A view schematically illustrating a configuration of a superconducting coil of a modification example of the third embodiment

FIG. 20 A view schematically illustrating a configuration of a superconducting coil of a modification example of the third embodiment

FIG. 21 A view schematically illustrating a configuration of a superconducting coil of a modification example of a fourth embodiment

FIG. 22 A view schematically illustrating a configuration of a superconducting coil of a modification example of the fourth embodiment

FIG. 23 A view schematically illustrating a configuration of a superconducting coil of a modification example of the fourth embodiment

FIG. 24 A view schematically illustrating a configuration of a superconducting coil of a modification example of the fourth embodiment

FIG. 25 A view schematically illustrating a configuration of a superconducting coil of a modification example of the fourth embodiment

FIG. 26 A view schematically illustrating a configuration of a superconducting coil of a modification example of the fourth embodiment

### DETAILED DESCRIPTION

A superconducting electromagnet device of the embodiment includes: a superconducting coil generating a magnetic field; a cooling mechanism cooling the superconducting coil; a radiation shield housing the superconducting coil thereinside to prevent heat intrusion from the outside; and a vacuum vessel for vacuum insulation which houses the radiation shield, wherein the cooling mechanism includes: a circumferential cooling unit having a plurality of strip-shaped circumferential cooling sheets arrayed each with an interval along a circumferential direction of the superconducting coil; and an axial cooling unit having a plurality of strip-shaped axial cooling sheets arrayed each with an interval along an axial direction of the superconducting coil.

According to embodiments of the present invention, it is possible to provide a superconducting electromagnet device which can suppress heat generation due to an eddy current of a coiling sheet for cooling a superconducting coil to thereby cool the superconducting coil efficiently, and a cooling method of the superconducting electromagnet device.

Hereinafter, embodiments of the present invention will be described with reference to the drawings.

### First Embodiment

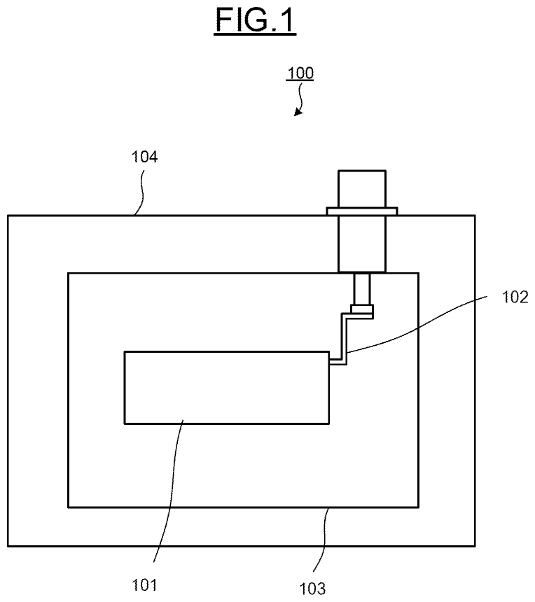

As illustrated in FIG. 1, a conduction cooling type superconducting electromagnet device 100 which has a saddle-shaped superconducting coil includes a superconducting coil 101 generating a magnetic field, a cooling mechanism cooling the superconducting coil 101, a radiation shield 103 housing the superconducting coil 101 thereinside to prevent heat intrusion from the outside, and a vacuum vessel 104 for vacuum heat insulation which houses the radiation shield 103. At a time of operation, a pulse current is made to flow through the superconducting coil 101.

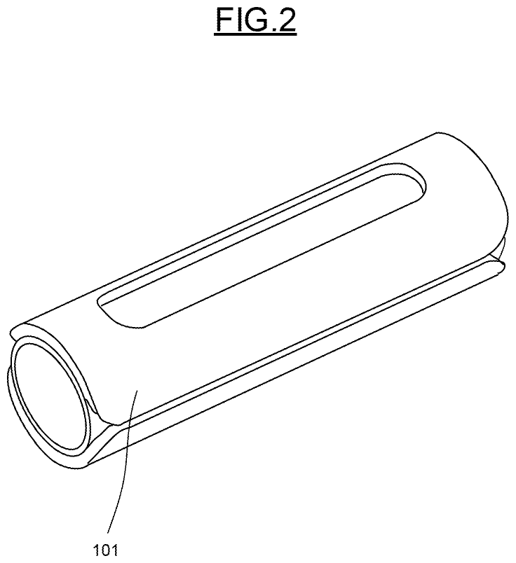

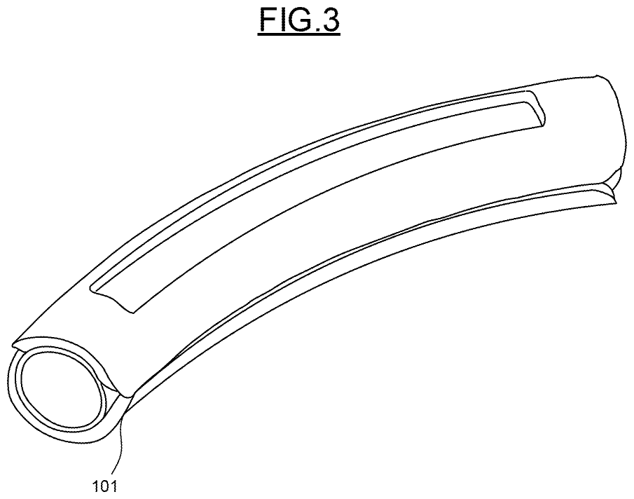

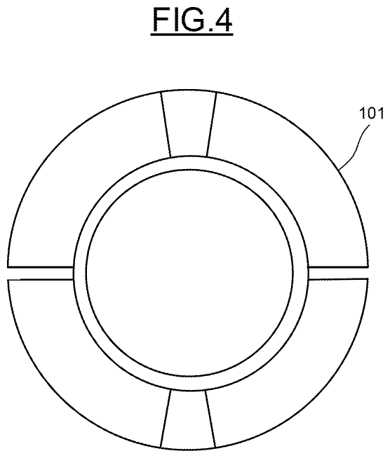

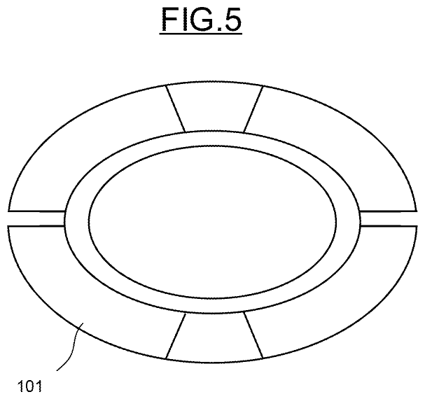

The superconducting coil 101 of this embodiment is called a saddle-shaped coil, and a winding shape of its superconducting wire is a saddle shape as illustrated in FIG. 2. However, an external form of the entire coil is almost cylindrical since an insulating sheet or the like is provided in addition to the superconducting wire. As the superconducting coil 101, in addition to a coil whose shape along an axial direction is linear, a coil of any shape can be used such as a coil whose shape along the axial direction is curved as illustrated in FIG. 3, for example. Further, as the superconducting coil 101 used in this embodiment, a coil of any shape can be used such as a coil whose shape in a circumferential direction is circular as illustrated in FIG. 4, or a coil whose shape in a circumferential direction is elliptic as illustrated in FIG. 5, for example.

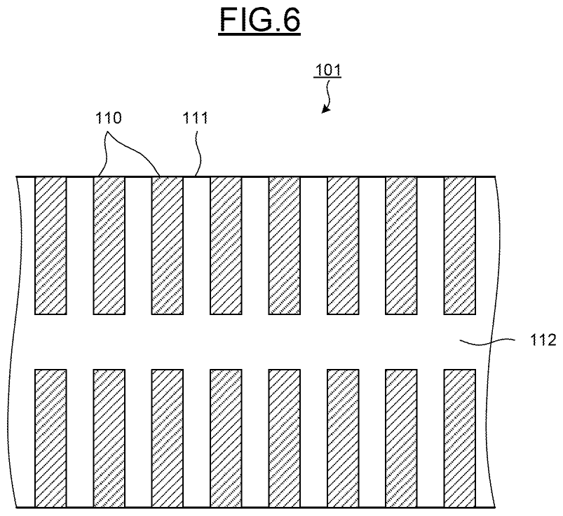

The superconducting coil 101 is provided with a cooling sheet formed of a pure aluminum sheet which constitutes the cooling mechanism 102. This cooling sheet, constituting a part of the cooling mechanism 102 illustrated in FIG. 1, is connected to a chiller provided on an outer side of the vacuum vessel 104 and cools the superconducting coil 101 by transmitting cold heat from the chiller. As illustrated in FIG. 6, on an outer circumferential side of the superconducting coil 101, a plurality of strip-shaped circumferential cooling sheets 110 is disposed while each being provided with a circumferential cooling sheet intervening gap (interval) 111 along a circumferential direction of the superconducting coil 101.

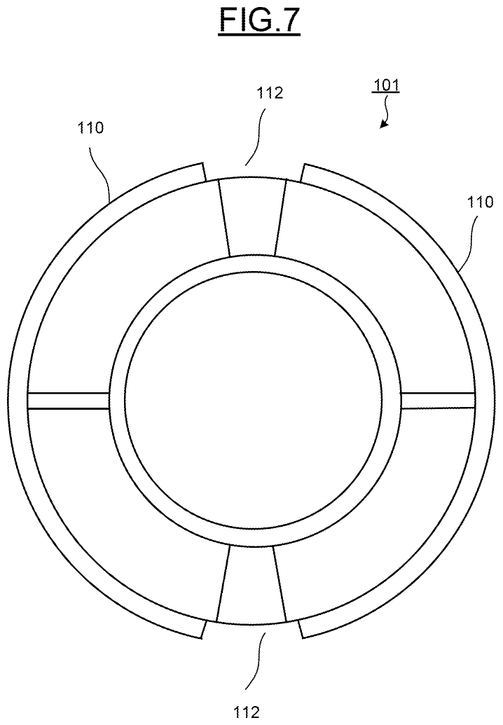

Further, the circumferential cooling sheet 110 is not disposed around the entire circumference of the superconducting coil 101, but is divided at a pole part where the coil is not disposed and is disposed while being provided with a circumferential cooling sheet dividing gap (interval) 112, as illustrated also in FIG. 7. In an example illustrated in FIG. 7, the coil has two poles, and parts on an upper side and a lower side in FIG. 7 are pole parts where the coil is not disposed, and the circumferential cooling sheet 110 is disposed while being provided with the circumferential cooling sheet dividing gaps 112 in these pole parts. In other words, the circumferential cooling sheets 110 are configured to be divided into two by the circumferential cooling sheet dividing gaps 112 along the circumferential direction, and configured to be plurally divided by the circumferential cooling sheet intervening gaps 111 along the circumferential direction.

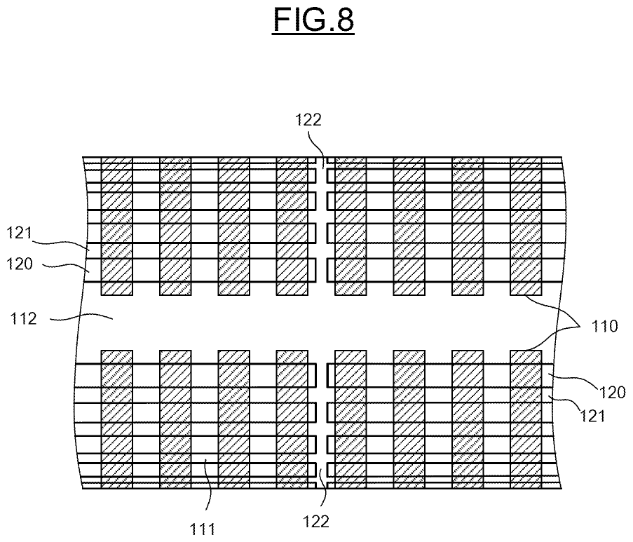

In an outer circumference of the above-described circumferential cooling sheet 110, as illustrated in FIG. 8, a plurality of strip-shaped axial cooling sheets 120 is disposed while each being provided with an axial cooling sheet intervening gap (interval) 121 along an axial direction of the superconducting coil 101. Further, the axial cooling sheet 120 is disposed while being provided with an axial cooling sheet dividing gap (interval) 122 in a middle part in the axial direction of the superconducting coil 101. In other words, the axial cooling sheets 120 are configured to be divided into two by the axial cooling sheet dividing gaps 122 along the axial direction, configured to be plurally divided by the axial cooling sheet intervening gaps 121 along the circumferential direction, and configured such that the respective axial cooling sheets 120 are not electrically connected to each other.

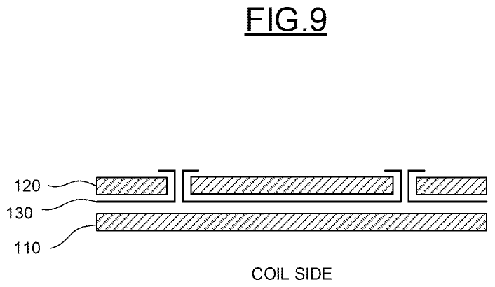

As illustrated in FIG. 9, an insulating seal such as a Kapton tape 130, for example, is disposed between the circumferential cooling sheet 110 and the axial cooling sheet 120, and the circumferential cooling sheet 110 and the axial cooling sheet 120 are electrically insulated by the Kapton tape 130. Further, the circumferential cooling sheet 110 is adhered on a coil side by an adhesive or the like formed of a resin, and to its outer circumference, the axial cooling sheet 120 is adhered by an adhesive or the like formed of a resin via the Kapton tape 130.

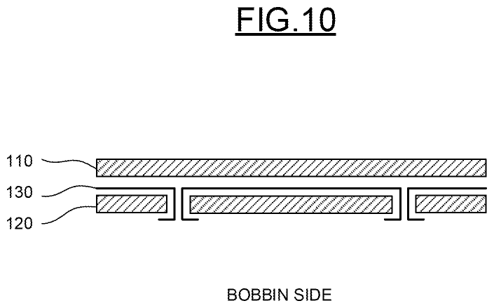

Note that FIG. 9 illustrates a case where the circumferential cooling sheet 110 and the axial cooling sheet 120 are provided on the outer circumferential side of the coil, but the circumferential cooling sheet 110 and the axial cooling sheet 120 may be provided on a bobbin side of the coil, that is, on an inner circumferential side of the coil as illustrated in FIG. 10.

In this case, it is preferable to dispose such that the axial cooling sheet 120 is positioned on the bobbin side and that the circumferential cooling sheet 110 is positioned on the coil side. In other words, it is preferable to dispose such that the circumferential cooling sheet 110 is positioned on the side of the position nearer to the coil. Thereby, when a quench occurs, heat due to the quench can be transmitted to the entire coil rapidly and efficiently by the circumferential cooling sheet 110. Note that FIG. 9 and FIG. 10 illustrate examples of configurations in which the Kapton tape 130 is provided on the axial cooling sheet 120 side, but the Kapton tape 130 may be provided on the circumferential sheet 110 side.

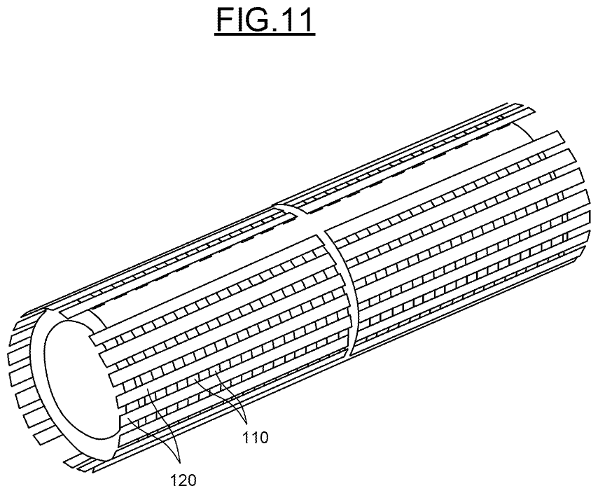

FIG. 11 schematically illustrates a configuration of the circumferential cooling sheet 110 and the axial cooling sheet 120 by a perspective view. Note that in the illustration of FIG. 11, for the sake of clarity, the number of the circumferential cooling sheets 110 and the number of the axial cooling sheets 120 are smaller than the actual numbers. The respective axial cooling sheets 120 are connected to the above-described chiller.

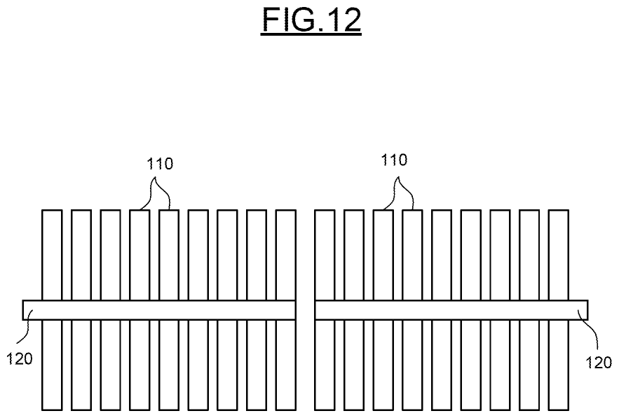

Further, in this embodiment, among the plural axial cooling sheets 120, as for one disposed in a predetermined axial position, that is, two in total in this embodiment since the axial cooling sheet 120 is divided into two in the axial direction (if the axial cooling sheet 120 is divided into two also in the circumferential direction, four in total in addition to those in the axial direction), the axial cooling sheet 120 is configured to be adhered to the circumferential cooling sheet 110 without intervention of the Kapton tape 130. Adoption of such a configuration can improve thermal conduction between the circumferential cooling sheet 110 and the axial cooling sheet 120. In this case, the configuration is that of a dendrite form where the axial cooling sheet 120 is one stem and the circumferential cooling sheets 110 are branches. A condition of a connected state in the above-described dendrite form of the axial cooling sheet 120 and the circumferential cooling sheet 110 is schematically illustrated in FIG. 12.

As described above, in the superconducting coil 101 of this embodiment, configuring the cooling mechanism by the circumferential cooling sheet 110 and the axial cooling sheet 120 of the above-described configuration can decrease an area of penetration of an interlinkage magnetic flux of the coil and a sectional area of occurrence of an eddy current.

In other words, the cooling sheets are divided in the axial direction and the circumferential direction, and in order to break an eddy current path in a longitudinal direction of the cooling sheet, the axial cooling sheet 120 is provided with the axial cooling sheet dividing gap 122 in a center part in the coil axial direction and the circumferential cooling sheet 110 is provided with the circumferential cooling sheet dividing gap 112 in the pole part of the coil. Further, the circumferential cooling sheet 110 and the axial cooling sheet 120 are insulated by the Kapton tape 130 or the like, which prevents an electrical path from being formed therebetween. Further, the configuration is such that any one of the axial cooling sheets 120 intersecting the circumferential cooling sheets 110 (two in total since the axial cooling sheet dividing gap 122 is provided to divide the axial cooling sheet 120) is directly in contact, without the Kapton tape 130 (dendrite form where the axial cooling sheet 120 is one stem and the circumferential cooling sheets 110 are branches), whereby a cooling effect is improved.

The cooling structure described above can drastically decrease the sectional area of occurrence of the eddy current compared with a conventional structure, enabling to lower a possibility of occurrence of a quench due to heat generation by the eddy current. Further, it is possible to cool the coil entirely and almost equally, and on the other hand, the above-described dendrite form structure can propagate the heat due to the quench to the entire coil efficiently at the time of the coil quench. Thereby, effects such as a decrease in number of the chiller and a decrease in coil load can be obtained.

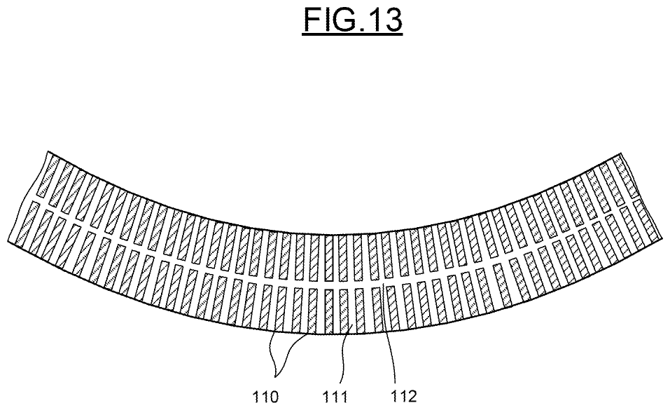

Note that in this embodiment, the example of the saddle-shaped coil is cited, but a shape is not limited as long as the coil is a superconducting coil through which a pulse-type direct current or alternating current flows. For example, the shape may be any one of a race track type, a positively curved type such as a solenoid, and a linear type. As a superconducting wire material, NbTi, Nb₃Sn, a high-temperature superconducting wire material (Y series, etc.) or the like can be used. Further, though the sectional shape of a magnetic field occurrence region is circular in the example of this embodiment, the sectional shape may be elliptic or quadrangular. For the cooling sheet, the high-purity aluminum sheet is used, but another metal with high heat conductivity in a cryogenic region may be used. Note that FIG. 13 illustrates an example of a state where a circumferential cooling sheet is adhered to a superconducting coil of a curved shape.

A place of installation of the cooling sheet may be a coil outer circumferential surface or a coil inner circumferential surface, and in a case where a plurality of coils is stacked, the place of installation may be between stacks. Further, any one of the above or plural places of installation may be adopted. Positions of the gaps dividing the axial and circumferential cooling sheets are provided in the center part in the coil axial direction as for the axial direction and in the coil pole part as for the circumferential direction in this embodiment, but as for the axial direction, the gap may be provided at a place other than the center part as long as the place is on the coil, and as for the circumferential direction, the gap may be provided at a place other than the pole part as long as the cooling sheet does not make a round.

As an insulation method between the cooling sheets, the Kapton tape 130 being the insulating sheet is installed on the axial cooling sheet 120 in this embodiment, but the Kapton tape 130 may not be installed on the axial cooling sheet 120 but installed on the circumferential cooling sheet 110, and the Kapton tapes 130 may be installed on both of the above. Further, insulation between the cooling sheets may be insulation by adhering a Kapton sheet with an insulating resin or may be insulation by direct coating with an insulating resin.

### Second Embodiment

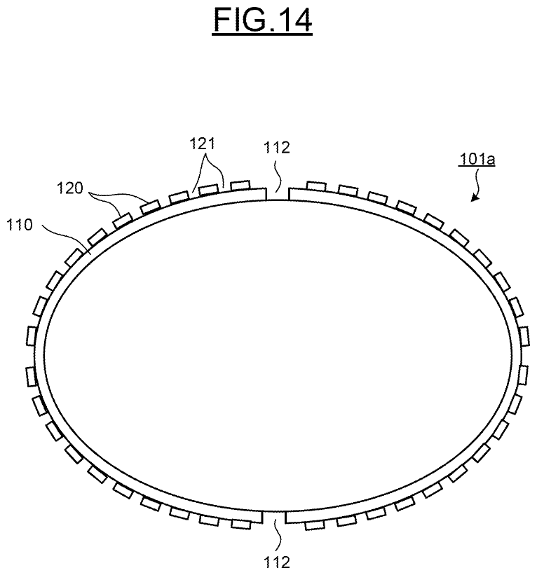

Next, a second embodiment will be described. A basic configuration is the same as that of the first embodiment, and a portion corresponding to that in the first embodiment will be given the same reference numeral, redundant explanation being omitted. FIG. 14 illustrates a configuration of a superconducting coil 101a of the second embodiment, and the superconducting coil 101a of the second embodiment will be described with an example of a case where a sectional shape of a magnetic field occurrence region is elliptic as illustrated in FIG. 14.

On an outer circumferential surface of the coil, as illustrated in FIG. 14, a circumferential cooling sheet 110 formed of a strip-shaped cooling sheet (a pure aluminum sheet in the second embodiment) is disposed in a circumferential direction of the coil. Similarly to the first embodiment, the circumferential cooling sheets 110 are configured to be divided into two by circumferential cooling sheet dividing gaps 112 along the circumferential direction, and configured to be plurally divided by circumferential cooling sheet intervening gaps 111 (not shown in FIG. 14) along the circumferential direction.

Further, as illustrated in FIG. 14, on an outer side of the circumferential cooling sheet 110, an axial cooling sheet 120 formed of a strip-shaped cooling sheet (a pure aluminum sheet in the second embodiment) is similarly disposed along an axial direction. Similarly to the first embodiment, the axial cooling sheets 120 are configured to be divided into two by axial cooling sheet dividing gaps 122 (not shown in FIG. 14) along the axial direction, and configured to be plurally divided by the axial cooling sheet intervening gaps 121 along the axial direction.

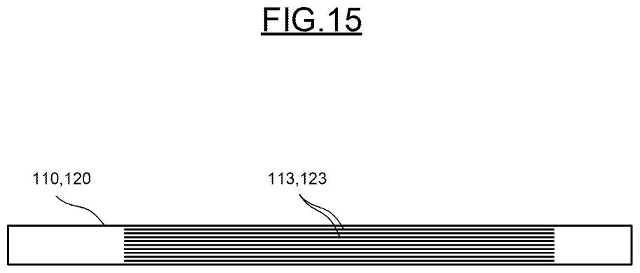

In other words, in the second embodiment, similarly to the first embodiment, the cooling sheet is constituted by the strip-shaped plural circumferential cooling sheets 110 and axial cooling sheets 120. In a part where a heating value of the coil is large in particular, as illustrated in FIG. 15, the configuration is such that a plurality of slits 113, slits 123 are provided in these strip-shaped plural circumferential cooling sheets 110 and axial cooling sheets 120 along longitudinal directions thereof.

As described above, in the second embodiment, the cooling sheets which cool the superconducting coil are divided in the axial direction and the circumferential direction so as to decrease an area of penetration of an interlinkage magnetic flux of the coil and a sectional area of occurrence of an eddy current, similarly to the first embodiment. Further, in order to break an eddy current path in a longitudinal direction of the cooling sheet, the axial cooling sheet 120 is provided with the axial cooling sheet dividing gap 122 in a center part in the coil axial direction, and the circumferential cooling sheet 110 is provided with the circumferential cooling sheet dividing gap 112 in a pole part of the coil. Further, in the second embodiment, in addition to the above, the configuration is such that the plural slits 113 and slits 123 are provided in a range where the heating value of the coil is large.

As a forming method of the slit 113 and the slit 123, laser cutting is used in this embodiment, but the forming method is not limited thereto and wire cutting may be used or manual cutting may be used.

Note that in this embodiment, an example of the saddle-shaped coil is cited, but a shape is not limited as long as the coil is a superconducting coil through which a pulse-type direct current or alternating current flows. For example, the shape may be any one of a race track type, a positively curved type such as a solenoid, and a linear type. Further, though a sectional shape of a magnetic field occurrence region is elliptic in the example of this embodiment, the sectional shape may be circular or quadrangular. For the cooling sheet, the high-purity aluminum sheet is used, but another metal such as high-purity copper or indium may be used as long as a material has high heat conductivity in a cryogenic region.

A place of installation of the cooling sheet may be a coil outer circumferential surface or a coil inner circumferential surface, and in a case where a plurality of coils is stacked, the place of installation may be between stacks. Further, any one of the above or plural places of installation may be adopted. Positions of the gaps dividing the axial and circumferential cooling sheets are provided in a center part in the coil axial direction as for the axial direction and in a coil pole part as for the circumferential direction in this embodiment, but as for the axial direction, the gap may be provided at a place other than the center part as long as the place is on the coil, and as for the circumferential direction, the gap may be provided at a place other than the pole part as long as the cooling sheet does not make a round. Other conditions are the same as in the first embodiment.

### Third Embodiment

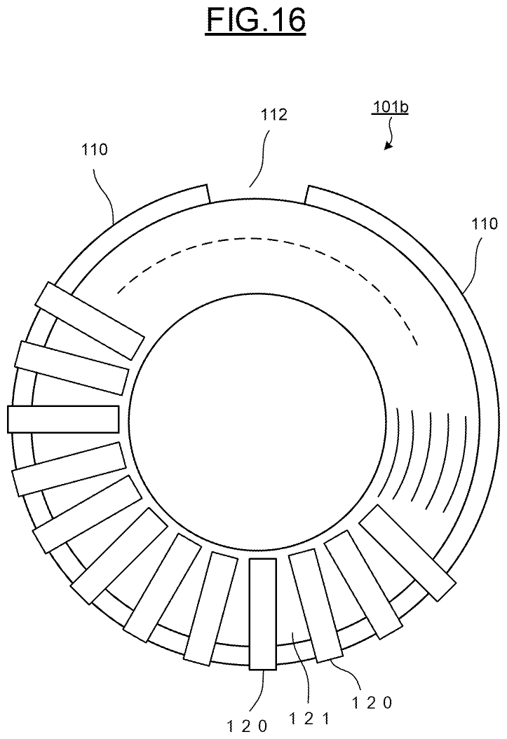

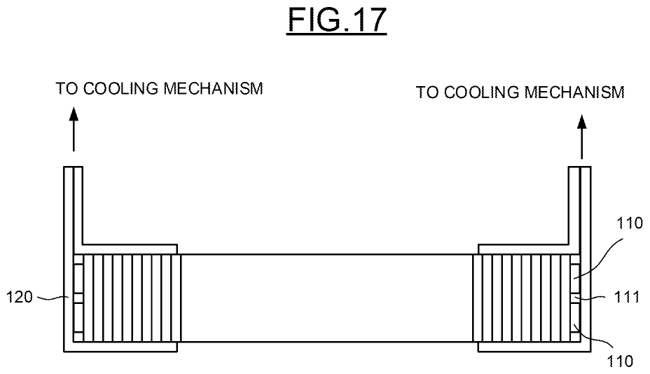

Next, a third embodiment will be described. A basic configuration is the same as that of the first embodiment, and a portion corresponding to that of the first embodiment will be given the same reference numeral, redundant explanation being omitted. FIG. 16 and FIG. 17 illustrate a configuration of a superconducting coil 101b of the third embodiment, and the superconducting coil 101b of the third embodiment will be described with an example of a case of what is called a pancake coil, as illustrated in those views. The pancake coil is configured by winding a tape-shaped wire rod, for example.

On an outer circumferential surface of this coil, a circumferential cooling sheet 110 formed of a strip-shaped cooling sheet (a pure aluminum sheet in the third embodiment) is disposed along a circumferential direction of the coil. The circumferential cooling sheets 110 are configured to have at least one circumferential cooling sheet dividing gap 112 along the circumferential direction, and configured to be plurally divided by circumferential cooling sheet intervening gaps 111 along the circumferential direction.

Further, on an outer side of the circumferential cooling sheet 110, an axial cooling sheet 120 formed of a strip-shaped cooling sheet (a pure aluminum sheet in the third embodiment) is similarly disposed along an axial direction. The axial cooling sheets 120 are configured to be plurally divided by axial cooling sheet intervening gaps 121 along the axial direction. Note that in FIG. 16, the axial cooling sheets 120 are disposed around the entire circumference, though the illustration of a part of the axial cooling sheets 120 is omitted. As illustrated in FIG. 17, the axial cooling sheets 120 are also provided on both surfaces of end parts in the axial direction of the superconducting coil 101b. The axial cooling sheet 120 is connected to a cooling mechanism.

In other words, in the third embodiment, similarly to the first embodiment, the cooling sheet is constituted by the strip-shaped plural circumferential cooling sheets 110 and axial cooling sheets 120.

As described above, in the third embodiment, the cooling sheets which cool the superconducting coil are divided in the axial direction and the circumferential direction so as to decrease an area of penetration of an interlinkage magnetic flux of the coil and a sectional area of occurrence of an eddy current, similarly to the first embodiment. As described above, the present invention can be applied to the pancake coil.

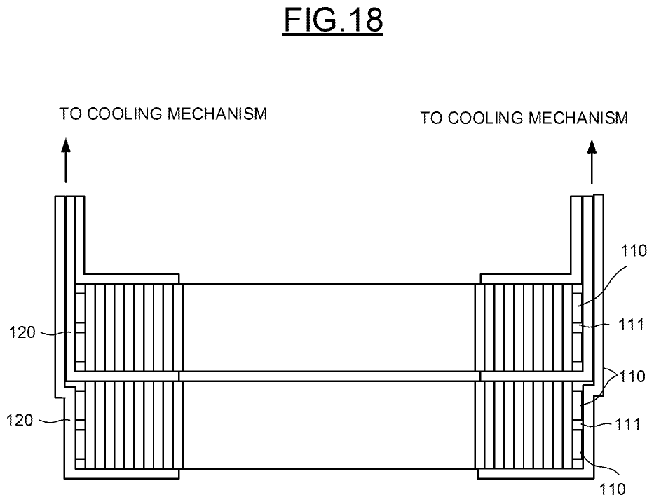

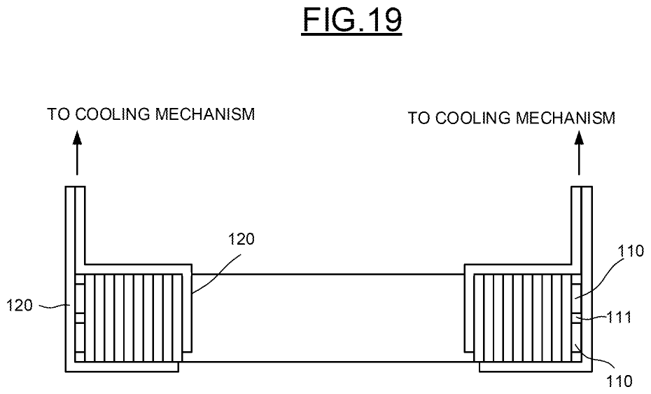

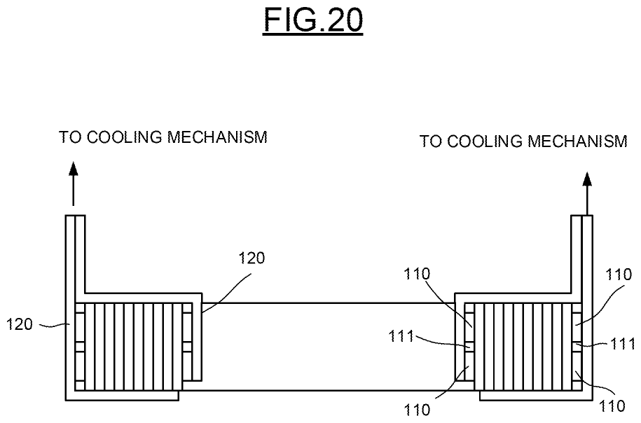

FIGS. 18, 19, and 20 are views illustrating configurations of modification examples of the third embodiment. FIG. 18 illustrates the example of the configuration in a case where a plurality of pancake coils is stacked. FIG. 19 illustrates the configuration example in which an axial cooling sheet 120 is also provided on an inner side of a pancake coil. FIG. 20 illustrates the configuration example in which in addition to an axial cooling sheet 120 a circumferential cooling sheet 110 is also provided on an inner side of a pancake coil.

### Fourth Embodiment

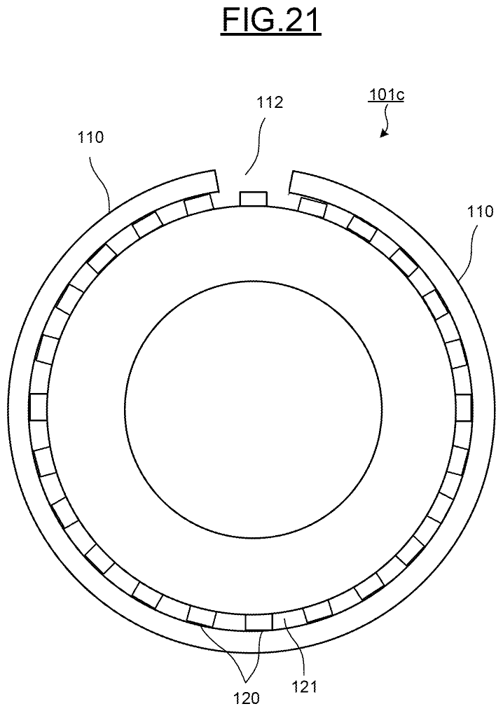

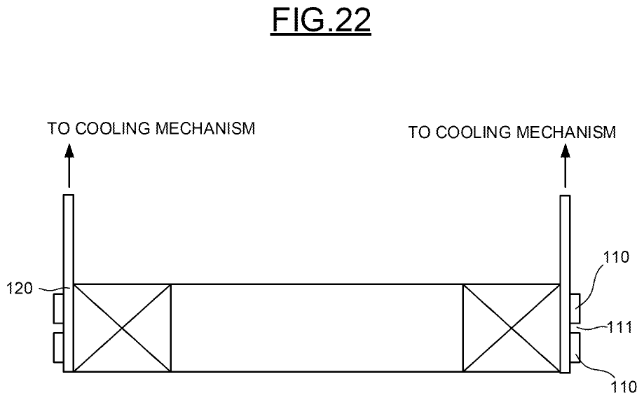

Next, a fourth embodiment will be described. A basic configuration is the same as that of the first embodiment, and a portion corresponding to that of the first embodiment will be given the same reference numeral, redundant explanation being omitted. FIG. 21 and FIG. 22 illustrate a configuration of a superconducting coil 101c of the fourth embodiment, and as illustrated in those views, the superconducting coil 101c of the fourth embodiment will be described with an example of a case of what is called a solenoid coil.

On an outer circumferential surface of this coil, a circumferential cooling sheet 110 formed of a strip-shaped cooling sheet (a pure aluminum sheet in the fourth embodiment) is disposed along a circumferential direction of the coil. The circumferential cooling sheets 110 are configured to have at least one circumferential cooling sheet dividing gap 112 along the circumferential direction, and configured to be plurally divided by circumferential cooling sheet intervening gaps 111 along the circumferential direction.

Further, on an inner side of the circumferential cooling sheet 110, an axial cooling sheet 120 formed of a strip-shaped cooling sheet (a pure aluminum sheet in the fourth embodiment) is similarly disposed along an axial direction. The axial cooling sheets 120 are configured to be plurally divided by axial cooling sheet intervening gaps 121 along the axial direction. The axial cooling sheet 120 is connected to a cooling mechanism. Note that the circumferential cooling sheet 110 and the axial cooling sheet 120 may be provided on an inner circumferential side of the superconducting coil 101c and may be provided on both of the outer circumferential side and the inner circumferential side.

In other words, in the fourth embodiment, similarly to the first embodiment, the cooling sheet is constituted by the strip-shaped plural circumferential cooling sheets 110 and axial cooling sheets 120.

As described above, in the fourth embodiment, the cooling sheets which cool the superconducting coil are divided in the axial direction and the circumferential direction so as to decrease an area of penetration of an interlinkage magnetic flux of the coil and a sectional area of occurrence of an eddy current, similarly to the first embodiment. Further, the circumferential cooling sheet 110 is provided with the circumferential cooling sheet dividing gap 112. As described above, the present invention can be applied also to the solenoid coil.

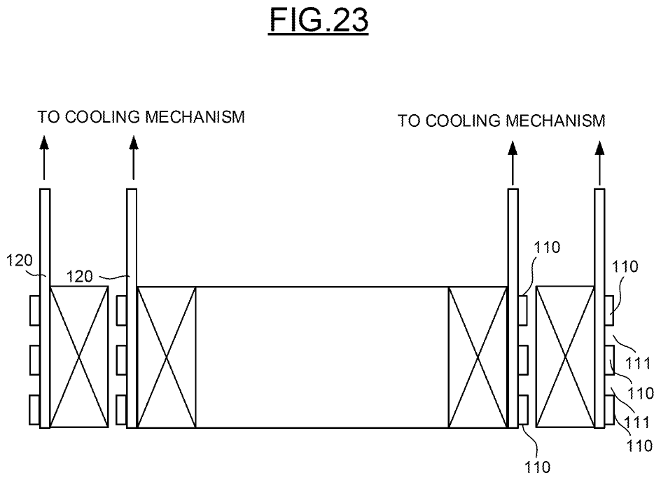

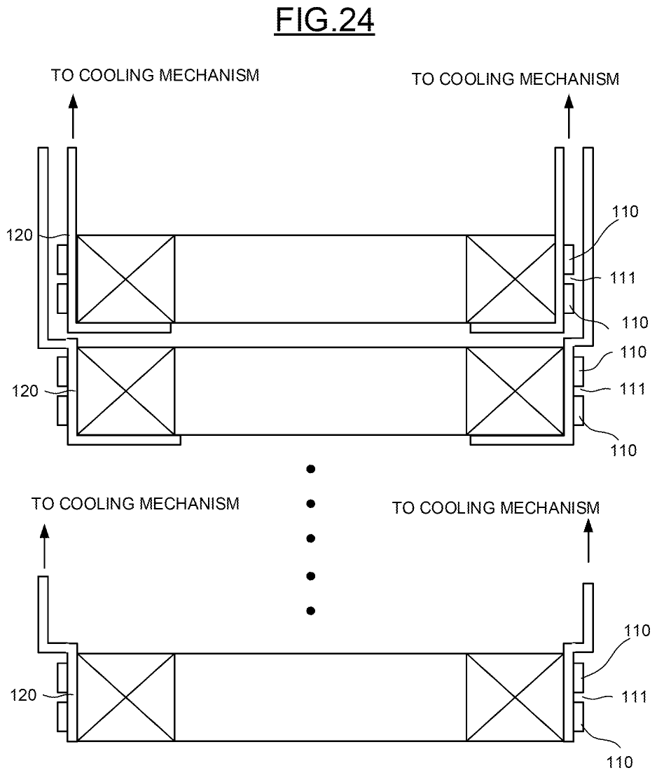

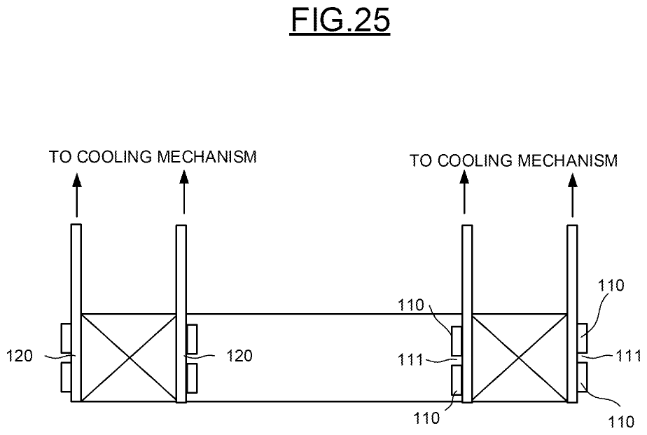

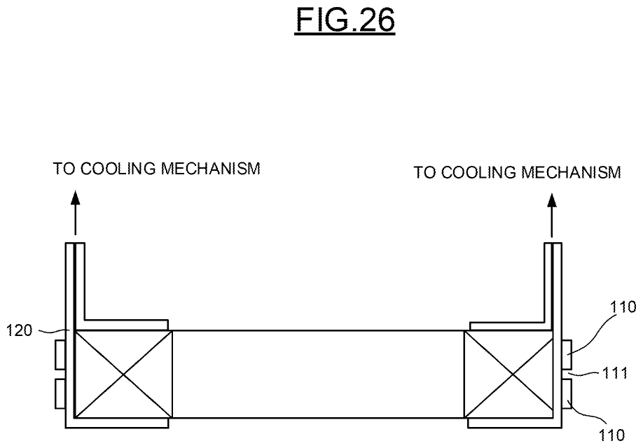

FIGS. 23, 24, 25, and 26 are views illustrating configurations of modification examples of the fourth embodiment. FIG. 23 illustrates the configuration example of a case where solenoid coils are disposed double on an inner side and an outer side. In this case, the solenoid coils may be disposed multiply such as triply or more. FIG. 24 illustrates the configuration example of a case where a plurality of solenoid coils is stacked. FIG. 25 illustrates the configuration example in which a circumferential cooling sheet 110 and an axial cooling sheet 120 are provided also in an inner side part of a solenoid coil. FIG. 26 illustrates the configuration example in which axial cooling sheets 120 are also provided on both side surfaces of end parts in an axial direction of a solenoid coil.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

### EXPLANATION OF REFERENCE NUMERALS

100 . . . superconducting electromagnet device, 101, 101a, 101b, 101c . . . superconducting coil, 102 . . . cooling mechanism, 103 . . . radiation shield, 104 . . . vacuum vessel, 110 . . . circumferential cooling sheet, 111 . . . circumferential cooling sheet intervening gap, 112 . . . circumferential cooling sheet dividing gap, 113 . . . slit, 120 . . . axial cooling sheet, 121 . . . axial cooling sheet intervening gap, 122 . . . axial cooling sheet dividing gap, 123 . . . slit, 130 . . . Kapton tape

What is claimed is:

1. A superconducting electromagnet device comprising:
a superconducting coil for generating a magnetic field;
a cooling mechanism for cooling the superconducting coil;
a radiation shield housing the superconducting coil thereinside to prevent heat intrusion from the outside; and
a vacuum vessel for vacuum insulation which houses the radiation shield, wherein
the cooling mechanism comprises:
a circumferential cooling unit having a plurality of strip-shaped circumferential cooling sheets arrayed each with an interval along a circumferential direction of the superconducting coil; and
an axial cooling unit having a plurality of strip-shaped axial cooling sheets arrayed each with an interval along an axial direction of the superconducting coil.

2. The superconducting electromagnet device according to claim 1, wherein
the circumferential cooling sheets are plurally divided in the circumferential direction of the superconducting coil.

3. The superconducting electromagnet device according to claim 2, wherein
the circumferential cooling sheets are divided at a pole part of the superconducting coil.

4. The superconducting electromagnet device according to claim 1, wherein
the axial cooling sheets are plurally divided in the axial direction of the superconducting coil.

5. The superconducting electromagnet device according to claim 4, wherein
the axial cooling sheets are divided at a center part in the axial direction of the superconducting coil.

6. The superconducting electromagnet device according to claim 1, wherein
the circumferential cooling unit and the axial cooling unit are disposed on an outer circumferential side or an inner circumferential side of the superconducting coil.

7. The superconducting electromagnet device according to claim 1, wherein
the circumferential cooling unit is disposed at a position nearer to the superconducting coil than the axial cooling unit.

8. The superconducting electromagnet device according to claim 1, wherein
an insulating sheet is disposed between the circumferential cooling sheet and the axial cooling sheet.

9. The superconducting electromagnet device according to claim 8, wherein
the insulating sheet is not disposed between the one axial cooling sheet or plural axial cooling sheets disposed along a predetermined axial position and the circumferential cooling sheet.

10. The superconducting electromagnet device according to claim 1, wherein
a slit is partially provided in at least either one of the strip-shaped cooling sheet of the circumferential cooling unit and the strip-shaped cooling sheet of the axial cooling unit.

11. A cooling method of a superconducting electromagnet device which comprises:
a superconducting coil for generating a magnetic field;
a cooling mechanism for cooling the superconducting coil;
a radiation shield housing the superconducting coil thereinside to prevent heat intrusion from the outside; and
a vacuum vessel for vacuum insulation which houses the radiation shield, the cooling method comprising
cooling the superconducting coil by the cooling mechanism which comprises:
a circumferential cooling unit having a plurality of strip-shaped circumferential cooling sheets arrayed each with an interval along a circumferential direction of the superconducting coil; and
an axial cooling unit having a plurality of strip-shaped axial cooling sheets arrayed each with an interval along an axial direction of the superconducting coil.
